(19) United States
(12) Patent Application Publication
(10) Pub. No.: US 2014/0128148 A1
(43) Pub. Date: May 8, 2014

(54) CONFLICT MONETIZATION METHOD AND SYSTEM

(71) Applicant: Yessenia Soffin, Boca Raton, FL (US)

(72) Inventor: Yessenia Soffin, Boca Raton, FL (US)

(21) Appl. No.: 13/794,650

(22) Filed: Mar. 11, 2013

Related U.S. Application Data
(60) Provisional application No. 61/723,585, filed on Nov. 7, 2012.

(51) Int. Cl. A63F 13/00

(52) U.S. Cl. CPC A63F 13/00
USPC 463/25

(57) ABSTRACT

A method for monetizing conflict with a game by allowing players to initiate a conflict during the game, selling a product and/or service during the game and conflict, and selling player information to a company for marketing and advertising purposes. An avatar, which represents the player, plays a game, such as poker, with other players. The player earns credits for winning the game. The player can choose to initiate a conflict, such as a physical fight, with at least one other player's avatar prior to, during, or after the game. The challenged player can accept or refuse the challenge. The other players can watch or bet on the outcome of the fight. A company can pay a fee to integrate a product or service into the game and/or the conflict. The player may purchase the product and/or service for the avatar to use during the game or conflict.

### CROSS-REFERENCE TO RELATED APPLICATIONS

The present Utility patent application claims priority benefit of the U.S. provisional application for patent Ser. No. 61/723,585, entitled “A Method for Monetizing Free Online Gaming Websites Using Avatars with User Information Collection and User Versus User Fight Sequences”, filed on 7-Nov.-2012, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

The following related U.S. patent application, submitted by at least one of the present Applicant(s)/Inventor(s) is recently co-pending: U.S. utility patent application Ser. No. 13/794,167, entitled “Game Monetization Method and System”, submitted to the United States Patent and Trademark Office (USPTO) on 11-Mar.-2013.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a conflict monetization method and system. More particularly, the invention relates to initiating a conflict during a game and selling player information for marketing purposes.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a game is a structured form of entertainment designed for the enjoyment of a player and generally incorporating goals, rules, challenge, interaction, and stimulation of the mind and body.

Typically, an online game is a video game played over some form of computer network, using a personal computer or video game console. This network is usually the internet or equivalent technology.

Typically, fighting is a purposeful violent conflict meant to weaken, or establish dominance over the opposition, kill the opposition, or drive the opposition away from a location where it is not wanted or needed. A fight may take place under a specific set of rules or be unregulated.

Typically, marketing is the process of communicating the value of a product or service to customers. Marketing may include the art of selling products. From a societal point of view, marketing is the link between a society's material requirements and its economic patterns of response. Marketing satisfies these needs and wants through exchange processes and building long term relationships.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate flowchart diagrams for an exemplary conflict monetization method that details an exemplary interaction between exemplary players during a conflict, an exemplary game administrator, an exemplary website, and an exemplary product company, in accordance with an embodiment of the present invention, where FIG. 1A illustrates an exemplary player playing the game to accrue conflict credits used for initiating a conflict or obtaining a product or service, and FIG. 1B illustrates an exemplary administrator agreeing with a company to integrate the product or service into the game;

FIG. 2 illustrates a flowchart diagram for an exemplary conflict monetization method that details an exemplary conflict initiated by a player during a poker game, in accordance with an embodiment of the present invention;

FIG. 3 illustrates a flowchart diagram for an exemplary conflict monetization method that details an exemplary monetization of the game by an administrator, in accordance with an embodiment of the present invention;

FIG. 4 illustrates an exemplary monetizing system, in accordance with an embodiment of the present invention;

FIG. 5 illustrates a flowchart diagram for an exemplary method for purchasing a product or service with an exemplary plurality of credits, in accordance with an embodiment of the present invention;

FIG. 6 illustrates a flowchart diagram for an exemplary method for playing an exemplary poker game, in accordance with an embodiment of the present invention;

FIG. 7 illustrates an exemplary virtual store that displays an exemplary product or service for purchase, in accordance with an embodiment of the present invention;

FIG. 8 illustrates an exemplary virtual store that displays information for an exemplary product or service purchased with a plurality of credits, in accordance with an embodiment of the present invention;

FIG. 9 illustrates an exemplary digital image in the form of an exemplary avatar having a plurality of attributes available for selection, in accordance with an embodiment of the present invention;

FIG. 10 illustrates an exemplary fight between two exemplary digital images representing players, in accordance with an embodiment of the present invention;

FIGS. 11A and 11B illustrate an exemplary poker game between a plurality of players, in accordance with an embodiment of the present invention, where FIG. 11A illustrates an exemplary graphical depiction of exemplary digital images positioned around a poker table, and FIG. 11B illustrates an exemplary dialogue box inviting the exemplary player to pay an exemplary plurality of credits to play the poker game;

FIGS. 12A, 12B, and 12C illustrate an exemplary poker game between a plurality of players, in accordance with an embodiment of the present invention, where FIG. 12A illustrates an exemplary virtual store displaying a plurality of exemplary products or services, FIG. 12B illustrates an exemplary digital image of an exemplary avatar with exemplary plurality of credits and game history, and FIG. 12C illustrates an exemplary dialogue box inviting an exemplary player to purchase a plurality of credits to play the poker game; and

FIG. 13 illustrates a block diagram of an exemplary computer system that, when appropriately configured or designed, may serve as an exemplary monetizing method and system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings.

There are various types of conflict monetization methods and systems that may be provided by preferred embodiments of the present invention. In one embodiment of the present invention, the conflict monetization method and system may monetize a game by allowing players to initiate a conflict during the game, and then selling player information to a company for marketing and advertising purposes. In some embodiments, a digital image, which represents the player, may be controlled by the player to initiate a conflict with at least one other player's digital image prior to, during, or after the game.

In another embodiment, the player may purchase a product or service integrated into the game by a company for the digital image to utilize. Those skilled in the art, in light of the present teachings, will recognize that combining a game, such as poker, with a conflict, such as a fist fight, may generate a high level of entertainment with certain demographics of players. The entertainment value may be efficacious towards generating good will towards a product or service displayed during the game or the fight. For example, without limitation, a branded beverage bottle may be used as a projectile in a fight between two players, and afterwards the players may drink the same beverage while sitting together at a poker table.

In one embodiment of the present invention, an administrator may collect player information for marketing and monetization purposes. The player information may include, without limitation, demographics, income, gender, and time spent playing the game. In some embodiments, the administrator may sell the player information to a company. The company may then market directly to the players after obtaining the player information from the administrator. In this manner, the game may be monetized. In some embodiments, the company may send advertising materials to the players while the game or conflict is in progress. However, in other embodiments, the advertising material may be sent by other means, including, without limitation, email, text, postal mail, and telephone. The company may provide their own advertising materials, or negotiate with the administrator what offers or coupons to deliver to the player. In yet another embodiment, the administrator may be responsible for the content of the advertisements.

In one embodiment of the present invention, the player may play the game with a preselected digital image configured to represent the player. The digital image may include, without limitation, a 3D avatar, a graphic, a logo, and a text. In some embodiments, the player may control the actions of the digital image during the game and during the conflict. The player may attempt to accrue a plurality of conflict credits and a plurality of regular credits while playing the game. In one embodiment, the plurality of conflict credits may be accrued or lost based on the performance of the player during the game. The conflict credits may be utilized to initiate a conflict with other players. The conflict credits may further be used to purchase a digital embodiment of a product or service from a virtual store. In this manner, the digital image representing the player may initiate a conflict with a digital image that represents another player, or utilize the product or service. In some embodiments, the player may challenge at least one additional player to a conflict, whereby if any of the challenged players accept the conflict challenge, the respective players may move to a different screen to commence the fight. However, in another embodiment, the player may initiate an aggressive blow towards another player during the game without initiating a challenge. In some embodiments, the conflict monetization method and system may require sufficient conflict credits from a player prior to initiation of a conflict. However, in other embodiments, the plurality of conflict credits may be utilized to update various attributes and characteristics of the avatar useful for fighting, including, without limitation, strength, dexterity, balance, quickness, and courage. For example, without limitation, ten credits may purchase increased stamina for enhancing the avatar's fighting capacity, or additional charisma for a poker game.

In one embodiment of the present invention, the player's digital image may initiate fights with other digital images. The fight may include, without limitation, a fist fight, a karate fight, a wrestling match, and an aggressive blow during a poker game. In yet another embodiment, the digital image of the player may include an avatar that displays and utilizes the product or service in a manner such that the player and/or additional players observe the avatar engaging with the product or service. Those skilled in the art, in light of the present teachings, will recognize that the player may observe the avatar utilizing the product or service. The observation of the avatar may include a visual or audio display of the product or service. For example, without limitation, a player may purchase a hat, and the player's avatar may then be shown wearing the hat. The avatar displaying the product or service may be configured to provide marketing for a company of the product or service. The marketing may include, without limitation, an advertisement, a newsletter, a coupon, a jingle, a reminder, and a demonstration of the product or service being utilized.

In one embodiment of the present invention, an administrator may regulate the game. The administrator may contact a company to integrate the product or service produced by the company into the game. The company may pay a fee to integrate the product or service into the game. In this manner, the player may purchase the product or services with the plurality of conflict credits accrued, and then observe the digital image utilizing the product or service. Those skilled in the art, in light of the present teachings, will recognize that a connection between successful game playing and the product or service may be formed in the player's psyche. The player may have an affinity towards the digital image. For example, without limitation, the digital image may include a personalized avatar that extenuates the personality features of the player, e.g., an altar ego of the player. By obtaining the product or service through the successful game playing of the avatar, a psychological bond between the player and the product or service may form. Furthermore, the company may have a marketing platform to display the product or service to the player throughout the game.

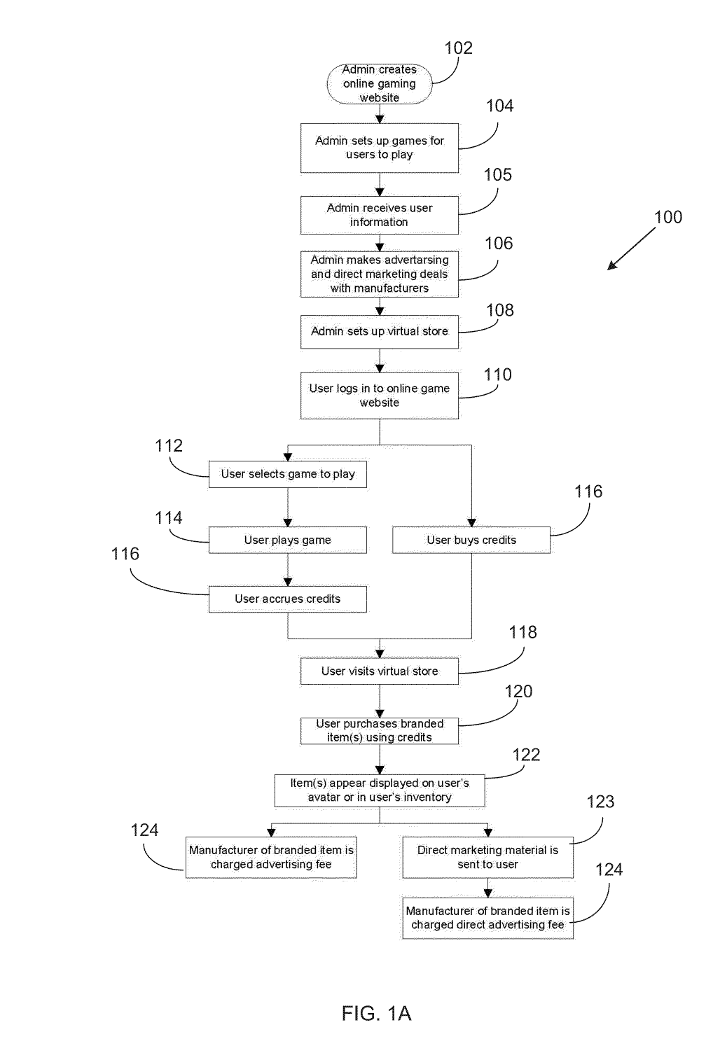

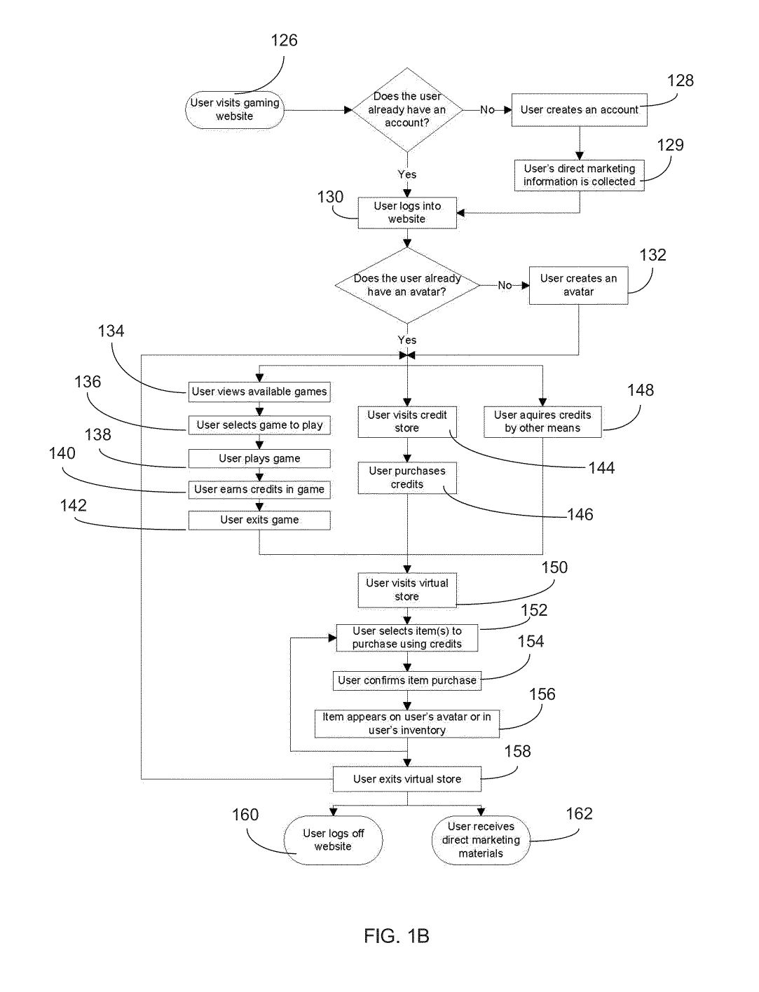

FIGS. 1A and 1B illustrate flowchart diagrams for an exemplary conflict monetization method that details an exemplary interaction between exemplary players during a conflict, an exemplary game administrator, an exemplary website, and an exemplary product company, in accordance with an embodiment of the present invention, where FIG. 1A illustrates an exemplary player playing the game to accrue conflict credits used for initiating a conflict or obtaining a product or service, and FIG. 1B illustrates an exemplary administrator agreeing with a company to integrate the product or service into the game. In the present invention, a conflict monetization method 100 may monetize a game by allowing players to initiate a conflict during the game, and then selling player information to a company. A digital image that represents the player may be controlled by the player to initiate a conflict with at least one other player's digital image during or after the game. In some embodiments, the digital image may also be viewed utilizing a product or service from the company. The player may purchase a product or service integrated into the game by a company for the digital image to utilize. In some embodiments, an administrator may collect player information for marketing purposes. The player information may include, without limitation, demographics, income, gender, and time spent playing the game. In some embodiments, the administrator may sell the player information to a company. The company may then market directly to the players after obtaining the player information from the administrator.

In one embodiment of the present invention, a first Step 102 may include an administrator creating an online game. The online game may include, without limitation, a poker game, an adventure game, and a sporting game. A Step 104 may include the administrator setting up the game for the player to play. The administrator may include skill levels, designs, languages, or other game variables suitable for different players. A Step 105 may include the administrator collecting player information for marketing and monetization purposes. In some embodiments, the administrator may sell the player information to a company. The company may then market directly to the players after obtaining the player information from the administrator. In some embodiments, a Step 106 may include the administrator agreeing with a company to integrate a product or service into the game. The administrator may monetize the game by charging the company every time the product or service is actuated during the game by the avatar of the player. A Step 108 may include the administrator setting up a virtual store in the game. The virtual store may display virtual products or services available for the player to exchange for a plurality of credits. The store may provide various information about the product or service, including, without limitation, cost, detailed specs, availability, and company marketing materials.

In one embodiment of the present invention, a Step 110 may include the player logging onto the game. The log in may include providing a password, providing personal information, and checking on the number of people in proximity to my street. A Step 112 may include the player selecting a game to play from a menu. Each game may be configured to depict a digital image, such as an avatar, acting in representation of the player. In one embodiment, the game may include, without limitation, a poker game, a blackjack game, a chess game, and a baseball game. A Step 114 may include the player playing the game. The player may play the game for entertainment and to accrue a plurality of credits. In some embodiments, a Step 116 may include the player accruing the plurality of credits through success while playing the game. However, in other embodiments, the player may purchase the plurality of credits with real money. A Step 118 may include the player visiting the virtual store to purchase a product or service for utilization by the avatar. In some embodiments, a Step 120 may include the player purchasing the desired product or service for the avatar. The product may include, without limitation, a food product, a garment, a weapon, and a document. A Step 122 may include the product or services appearing with the avatar. The avatar may display or demonstrate the product or service for the player or additional players. For example, without limitation, the avatar may drink a soda purchased with the plurality of regular credits by the player. The brand name of the soda may be prominently displayed by the avatar in a winning pose. In a Step 123, advertising material may be sent to the player the company may send advertising materials to the players while the game or conflict is in progress. However, in other embodiments, the advertising material may be sent by other means, including, without limitation, email, text, postal mail, and telephone. The company may provide their own advertising materials, or negotiate with the administrator what offers or coupons to deliver to the player. In yet another embodiment, the administrator may be responsible for the content of the advertisements.

In one embodiment of the present invention, a Step 124 may include the company paying a fee to the game administrator to integrate the company's product or service into the game. In some embodiments, the company may pay a fee for every click or attempt to access the product in the virtual store. However, in another embodiment, the company may pay a fee every time the player views the product or service. For example, without limitation, when the player clicks on a shirt, the administrator may have agreed with a Tommy Bahama shirt company to pay for either a cost per click in which just the Tommy Bahama shirts may be displayed in the store, or a cost per view where the player may click on the desired shirt. In some embodiments, a 5-15 second ad for Tommy Bahama may run in view of the player. In one alternative embodiment, the player may be contacted with email offering additional advertising each time the preselected product is chosen by the player. The email may include a store coupon for Tommy Bahama shirts. Those skilled in the art, in light of the present teachings, will recognize that companys that participate in advertising through a free gaming website may also utilize direct marketing campaigns. For example, without limitation, a player may purchase an avatar of a company's product in the virtual store and the company may be charged the respective fee for that transaction. The company may then have the option to purchase direct marketing services from the administrator for a fee similar to the advertising fee. In one embodiment of the present invention, the company may choose to have direct marketing such as, but not limited to, a coupon or other offer delivered to the player every time the player purchases the company's avatar from the virtual store. In another embodiment, the player may be added to a direct marketing list that is delivered to the player at specified intervals. In yet another embodiment, the company may purchase the ability to have direct marketing delivered to the player without the player purchasing an avatar of that company's product or service.

In one embodiment of the present invention, a Step 126 may include the player visiting the game. The player may log onto a free gaming website, choose a game to play, and play the game. In one alternative embodiment, if the player does not have an account with the game, a Step 128 may include the player creating an account. Those skilled in the art, in light of the present teachings, will recognize that creating an account may include the player providing personal information and credit card information. A Step 129 may include the player information being collected. The player information may include, without limitation, demographics, income, gender, and time spent playing the game. In some embodiments, a Step 130 may include the player logging onto the game to play. If the player does not have a digital image in the form of an avatar, a Step 132 may include the player creating an avatar with a desired set of characteristics and attributes. The player may select from a plurality of attributes including, without limitation, species, gender, hair color, dexterity, speed, intelligence, and charisma. After selecting the desired avatar, a Step 134 may include the player viewing possible games to play, including, without limitation, poker, blackjack, checkers, baseball, and basketball. The games may include, without limitation, a poker game, an adventure game, and a sport game. A Step 136 may include the player selecting the desired game to play from a menu of games. A Step 138 may include the player playing the game through the avatar. A Step 140 may include the player earning a plurality of conflict credits or regular credits by successfully playing the game. The credits may be accrued through various means, including, without limitation, winning a hand of cards, slaying a dragon, and scoring a goal. In some embodiments, as the player plays the game, certain methods for collecting a plurality of credits, including, without limitation, frequent player points, loyalty points, and virtual currency may be accrued. The methods for collecting credits may include, but are not limited to, credits being encountered randomly or in specific locations or areas in the game, earning credits for accomplishing a goal such as, but not limited to, completing a level, defeating an enemy, or completing predefined achievements, winning competitions with other human or computer-controlled players, selling items in a store or having other players send the user a gift of credits.

A Step 142 may include the player exiting the game without making any purchases, whereby the player simply plays the game for entertainment. However, in another embodiment, a Step 144 may include the player visiting a credit store to purchase additional conflict credits or regular credits. A Step 146 may include the player purchasing a plurality of conflict or regular credits with money. In some embodiments, the player may utilize a credit card to purchase the conflict credits. A Step 148 may include the player acquiring the conflict credits through various means, including, without limitation, winning the game, scoring points, bartering with other players, and decreasing the attributes of the avatar. A Step 150 may include the player visiting the virtual store to purchase a product or service for the avatar to utilize. A Step 152 may include the player selecting the product or service to purchase from a menu of products or services. The product or service may include a brand name or logo prominently displayed for the player to view. In some embodiments, the plurality of credits may be deducted upon completion of the transaction. A Step 154 may include the player confirming the purchase of the product or service. A Step 156 may include the product or service appearing in the player's avatar inventory. The digital image, in the form of an avatar may then have access to the product or service. A Step 158 may include the player exiting the game. A Step 160 may include may include the player logging off of the online game. In one alternative embodiment of the present invention, the gaming website may include a lottery at intervals such as, but not limited to, hourly, daily, weekly, and monthly. Winning players of the lottery may be awarded a preset amount of credits, or an amount determined by an algorithm. In some embodiments, the lottery may have one or more winners. The lottery may award credits or items from a virtual store. In some embodiments, a Step 162 may allow the player to receive advertising material from the company, even after logging off of the game site.

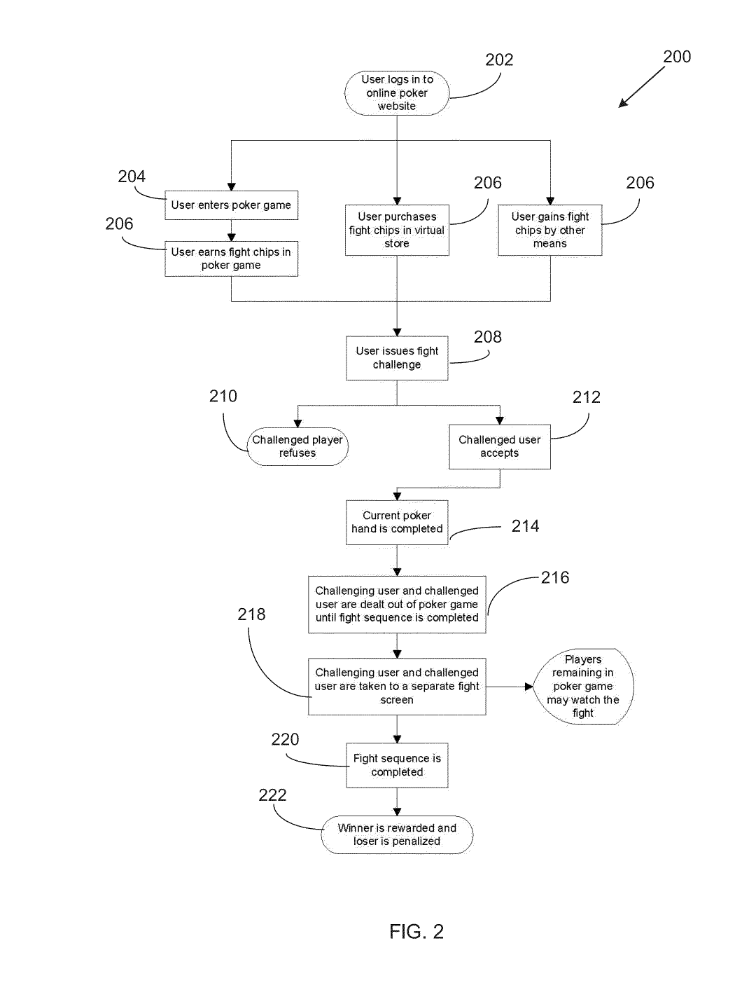

FIG. 2 illustrates a flowchart diagram for an exemplary conflict monetization method that details an exemplary conflict initiated by a player during a poker game, in accordance with an embodiment of the present invention. In the present invention, the conflict monetization method 200 may allow the player to challenge at least one additional player to a conflict, whereby if any of the challenged players accept the conflict challenge the respective players may move to a different screen to commence the fight. However, in another embodiment, the player may initiate an aggressive blow towards another player during the game without initiating a challenge. In some embodiments, the conflict monetization method and system may require sufficient conflict credits from a player prior to initiation of a conflict. The player may challenge at least one additional player to a conflict, whereby if any of the challenged players accept the conflict challenge, the respective players may move to a different screen to commence the fight. However, in another embodiment, the player may initiate an aggressive blow towards another player during the game without initiating a challenge. In some embodiments, the conflict monetization method and system may require sufficient conflict credits from a player prior to initiation of a conflict.

In one embodiment of the present invention, a Step 202 may include the player logging in to a poker game on the internet. However, in other embodiments, the game may include a game of chance, including, without limitation, black jack, rummy, and bingo. After logging in, the player may select a free gaming website. The player may then select a game to play, and begins to play the game. In some embodiments, a Step 204 may include the player joining a poker game. The poker game may have already dealt the cards, so the player may have to wait for a new hand to be dealt. A Step 206 may include the player earning conflict credits by playing winning hands in the poker game. For example, without limitation, if the player bets twenty conflict credits and plays a full house, the player may receive a plurality of conflict credits from the other players that exceed twenty conflict credits. However, the player may also lose conflict credits by losing the poker game. Those skilled in the art, in light of the present teachings, will recognize that certain methods for obtaining the conflict credits, loyalty points, or some other type of virtual currency may include, without limitation, completing predefined achievements, winning games, competitions or tournaments against other players, selling items in a store, or having other players send the user a gift of credits.

In one embodiment of the present invention, a Step 208 may include the player issuing a conflict challenge to at least one other player. The conflict challenge may include, without limitation, a fight, an arm wrestling match, a debate, and a dance contest. For example, without limitation, the online poker game may include a built-in feature whereby players in a virtual game room or lobby may challenge other players to a fight. While the player is engaged in a virtual poker game, the player has the opportunity to challenge another player to a fight. The player may issue a challenge to another player by pressing a challenge button and then selecting a player to challenge, or by pressing a challenge button next to another player's avatar. In some embodiments, a player must have a specified number of conflict credits available to be able to initiate a challenge. In one embodiment of the present invention, a player may only issue a challenge between hands of poker. In another embodiment, a player may issue a challenge at any time. In another embodiment, the fight sequence is automatically initiated between the last two players remaining in the virtual poker game, or the fight sequence is restricted to the last two players in the game so that no fight sequence may take place if there are three or more players. If a challenge is issued before completion of a hand, the hand is finished before the fight starts. In another embodiment, instead of a fight sequence, a punch sequence may be initiated, where a player chooses to punch another player using fight chips. This may result in the punched player forfeiting the hand, losing credits, losing fight chips, losing an avatar item, or another negative effect.

In one embodiment of the present invention, a Step 210 may include the challenged player selecting to either refuse or accept the conflict challenge. The challenged player may be forced to accept the challenge, or the challenged player may refuse the challenge. Refusal of a challenge may have certain consequences, such as, but not limited to, forfeiture of a certain amount of fight chips or regular credits. The challenged player may weigh various variables prior to making the decision, including, without limitation, interest in the poker game, amount of conflict credits available, fighting skill level, and risk aversion. In some embodiments, a Step 212 may include the challenged player accepting the conflict challenge. In one alternative embodiment, teams of players may join together to accept the challenge, whereby a gang fight between a plurality of groups may ensue. In some embodiments, a Step 214 may include the current poker game being completed prior to the commencement of the conflict. In this manner, players that are not participating in the conflict do not have to be interrupted in the middle of a poker hand. A Step 216 may include the players involved in the conflict being dealt out of subsequent poker games. In this manner, the conflict may commence. In some embodiments, a Step 218 may include the players involved in the conflict moving to a separate screen to commence the conflict. For example, without limitation, after a hand in a poker game is completed, the players involved in the fight sequence are taken to a fight screen and omitted from the next hand of poker and all subsequent hands until the fight sequence is completed. In some embodiments, the players not involved in the conflict may view the conflict while still playing the game. The players not involved in the fight may place bets on the outcome of the fight, using various valuables, including, without limitation, regular credits, conflict credits, virtual products or services, and real money. In some embodiments, for the players not engaged in the fight sequence, a small banner sized window may appear for viewing the fight. Each player not participating in the fight has the option to close the window if they so choose. In one alternative embodiment, the players not involved in the conflict may bet on the outcome of the conflict.

In one embodiment of the present invention, a Step 220 may include the commencement and completion of the conflict, which may include a fight. In some embodiments, the player's avatar may be killed during the fight, whereby the player must select or purchase a different avatar to continue playing in future games. In one embodiment, a fight sequence may include, without limitation, a one-on-one, two dimensional, side view, real-time fighting game similar to previously known fighting games. The conflict between players may be similar to fighting games including, without limitation, Street Fighter™, Mortal Kombat™, or Tekken™. In yet another embodiment, the fight sequence may include isometric view, turn-based, and involves a variety of weapons, armor and other items that can be equipped by the players. In another embodiment, more than two players may be involved in the fight sequence for a brawl sequence. In another embodiment, each individual player has personal fight statistics and characteristics, such as, but not limited to, character level, strength, hit points, defense, speed, or special maneuvers, that can be upgraded, without limitation, by purchasing upgrades in the virtual store, winning fights, and winning poker games. In some embodiments, a Step 222 may involve a winning player being rewarded, and a losing player being penalized. In one embodiment, the winning player may receive rewards, while the losing player is penalized. The winning player may receive rewards, including, without limitation, a certain number of conflict credits or regular credits, and an item from the virtual store. For example, without limitation, the winning player may receive the losing player's conflict credits. The winning player may also receive any products or services that the losing player's avatar possesses. In some embodiments, the winning player may steal an item or conflict credits from the losing player, and the losing player may have to pay for the fight with their conflict credits. Awards may be given to players at certain intervals for achievements such as, but not limited to, most fight wins, quickest fight, and best record.

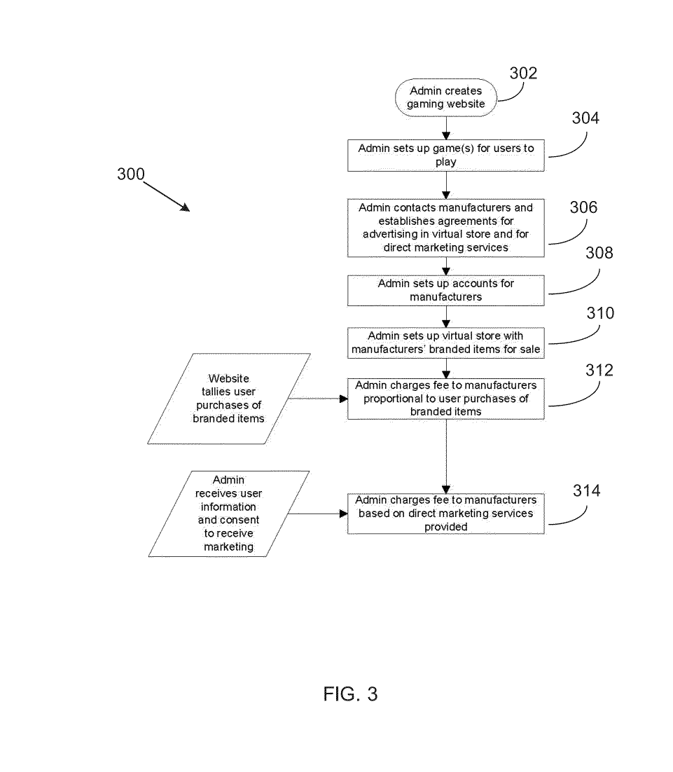

FIG. 3 illustrates a flowchart diagram for an exemplary conflict monetization method that details an exemplary monetization of the game by an administrator, in accordance with an embodiment of the present invention. In the present invention, an administrator may sell player information or product placement in a game to monetize the game. A company may pay for the player information or the right to display a product or service in the game. In some embodiments, a first Step 302 may include an administrator creating an online game. The online game may include, without limitation, a poker game, an adventure game, and a sporting game. A Step 304 may include the administrator setting up the game for the player to play. The administrator may include skill levels, designs, languages, or other game variables suitable for different players. A Step 306 may include the administrator contacting the company, and agreeing to provide player information for direct advertising and presenting the product or service into the game. In some embodiments, a Step 308 may include the administrator setting up an account for the company. In this manner, the company may receive the player information more efficiently.

In one embodiment of the present invention, a Step 310 may include the administrator setting up a virtual store with the company's product or service. The digital image of the player may then access the product or service in the virtual store. In some embodiments, a Step 312 may include the administrator may charge a fee to the company in proportion to the player's purchase or viewing of the product or service. Those skilled in the art, in light of the present teachings, will recognize that the conflict monetization method may automatically tally the visits and purchases of the player to the company's virtual store. A final Step 314 may include the administrator selling the player information and accessibility to the product or service to the company. The company may then market directly to the players after obtaining the player information from the administrator. In this manner, the game may be monetized. Those skilled in the art, in light of the present teachings, will recognize that the player may be notified or asked permission prior to the player information being shared with the company.

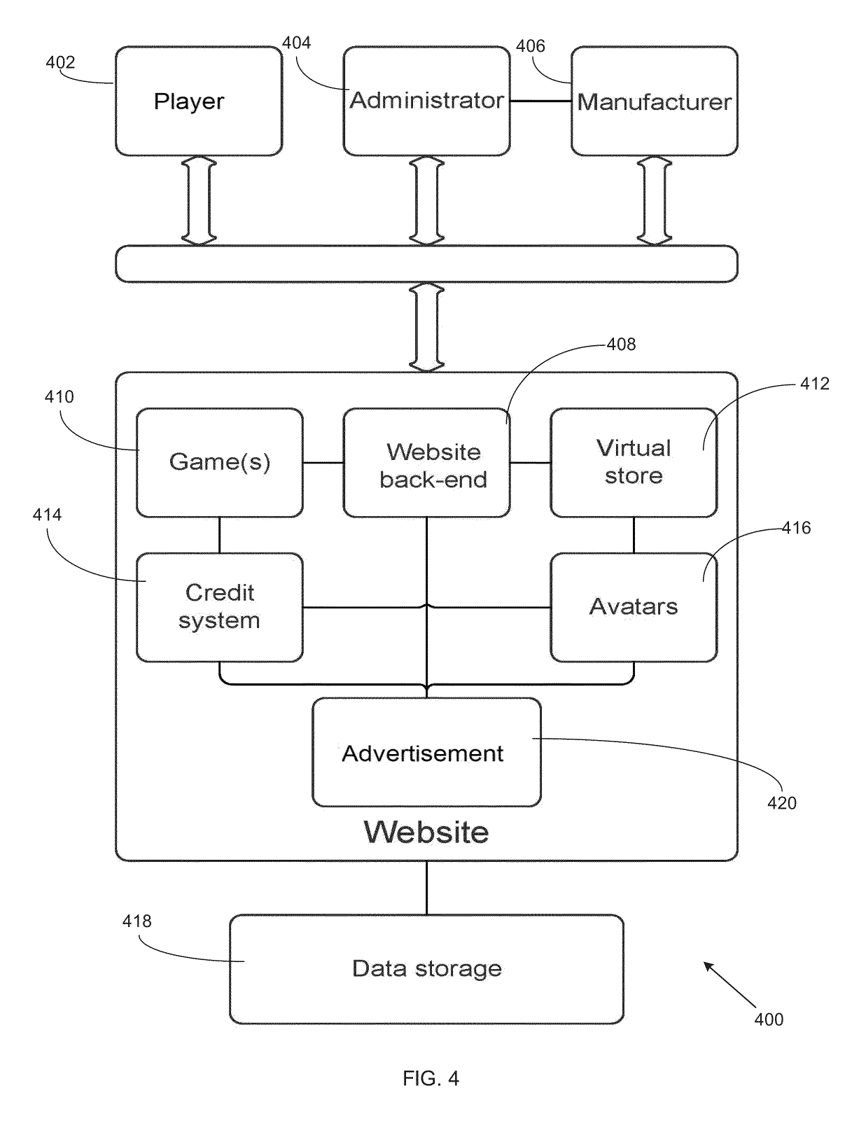

FIG. 4 illustrates an exemplary monetizing system, in accordance with an embodiment of the present invention. In the present invention, system 400, player 402, game administrator 404, and company 406 communicate with website 408. Company 406 may register with game administrator 404 to integrate a product or service into a game 410 through a virtual store 412. The player may accrue a plurality of credits 414 by successfully playing the game. The player may utilize a digital image 416 for representation during the game. The digital image may include, without limitation an avatar that displays or demonstrates the product or service in the form of an advertisement 420. A data storage site 418 may store registration information pertaining to the product or service, including, without limitation, amount of times product or service displays, amount of credits player accrues, and transfer of monetary funds from the company to the administrator for permission to integrate the products or services into the game. Administrator may transfer information to data storage site. Data storage site may format and store transferred information. A communication server may transfer the information to an external social site.

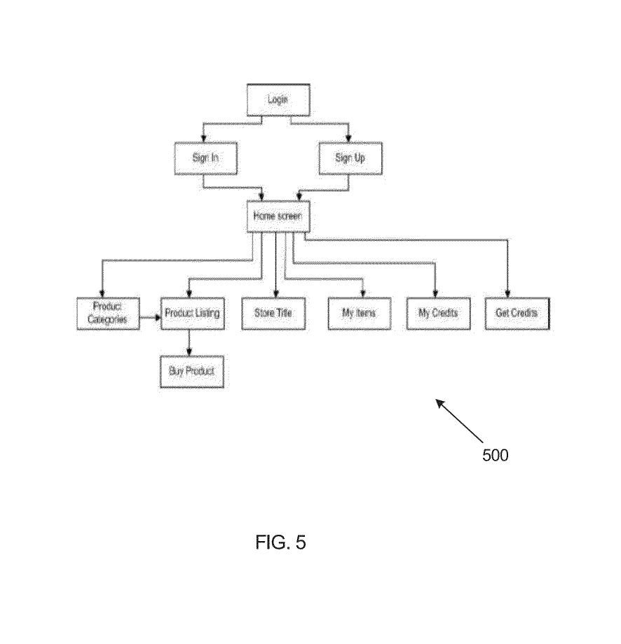

FIG. 5 illustrates a flowchart diagram for an exemplary method for purchasing a product or service with an exemplary plurality of credits, in accordance with an embodiment of the present invention. In the present invention, the method for purchasing the product or service 500 may allow the player to purchase the product or service from a virtual store with a plurality of credits obtained either through playing the game or purchase with monetary funds. However, in other embodiments, the plurality of credits may be utilized to update various attributes and characteristics of the avatar. For example, without limitation, ten credits may purchase increased dexterity for an adventure game, or additional charisma for a poker game.

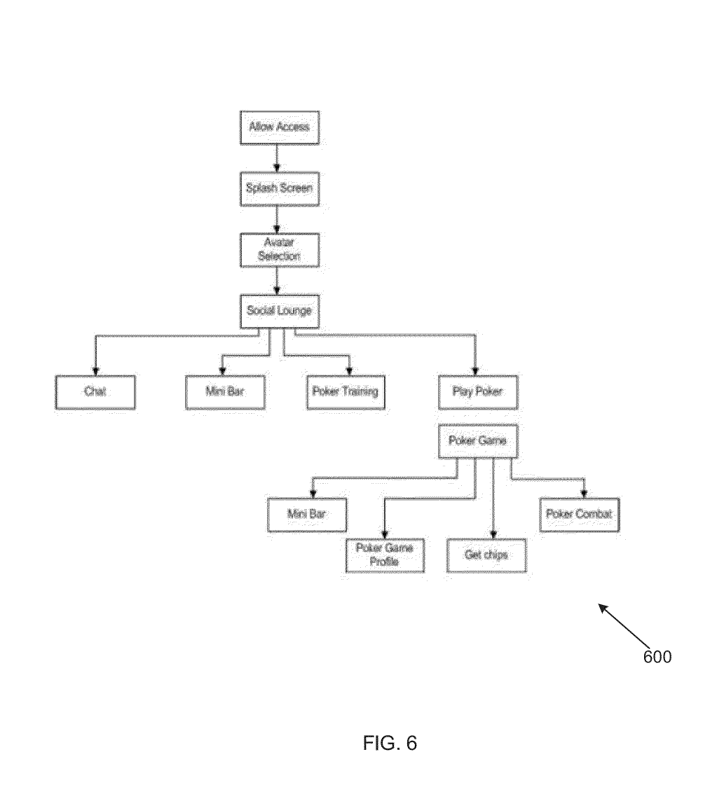

FIG. 6 illustrates a flowchart diagram for an exemplary method for playing an exemplary poker game, in accordance with an embodiment of the present invention. In the present invention, the method for playing an exemplary poker game 600 may provide a forum for the player to play a poker game against the game, or against additional players. In the poker game embodiment, the plurality of credits may be accrued by the player by betting the credits in a similar manner to how chips or money are traditionally bet in poker. In another embodiment, the credits may accrue automatically in a manner proportional to the number of games played or to the amount of time spent playing the game. The player may then visit the virtual store to purchase the desired product or service.

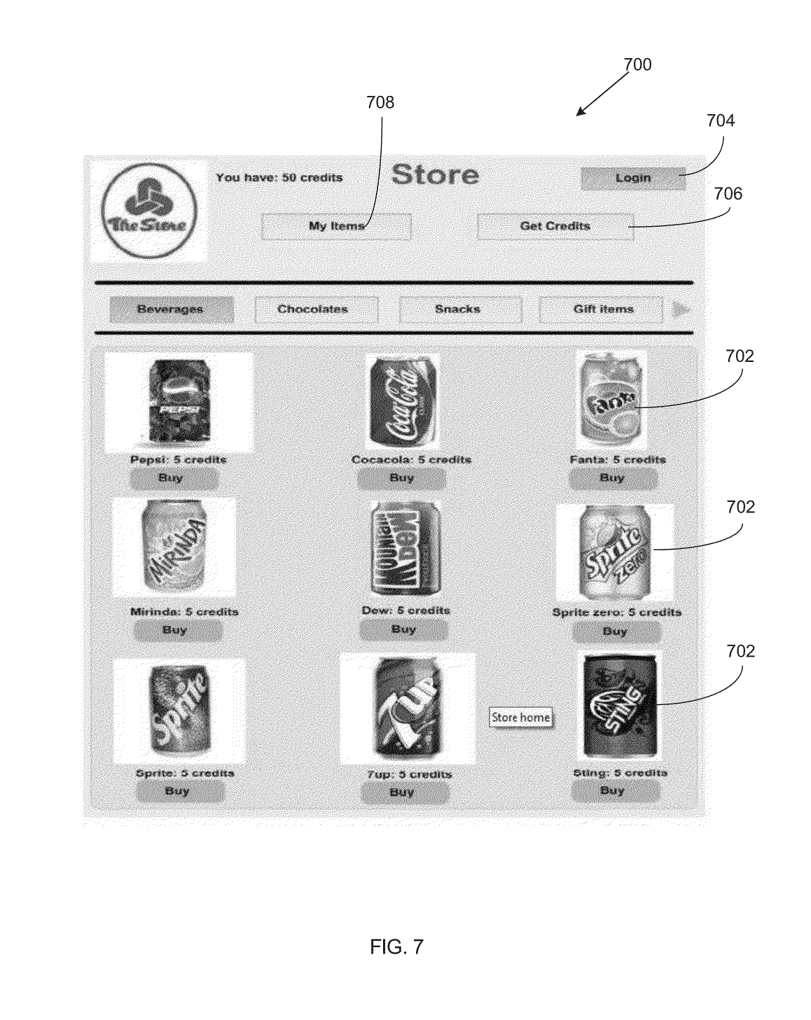

FIG. 7 illustrates an exemplary virtual store that displays an exemplary product or service for purchase, in accordance with an embodiment of the present invention. In the present invention, the store may include a virtual store 700 that displays a plurality of products or services 702 displayed in proximity to each other. In some embodiments, the products or services may include, without limitation, beverages such as soda, juice or alcoholic beverages, cigars, or any other item the website administrator decides to make available. Other examples of products or services may include, without limitation, clothing, logos, hairstyles, or other customizations for the avatar. In some embodiments, each product or service may display next of a similar product. For example, without limitation, colas could be displayed on a graphical menu. The player may then select the cola for the avatar to drink, or to offer another player's avatar. In one embodiment, the store may include a login portion 704, whereby the player may access the store. In one alternative embodiment, the player may utilize a password to access the store. A credit access portion 706 may allow the player to purchase additional credits for purchasing the products or services in the store. A product inventory portion 708 may allow the player to check the inventory of products or services that the player has acquired for the avatar. In this manner, the player may view, purchase, and consolidate products or services while playing the game.

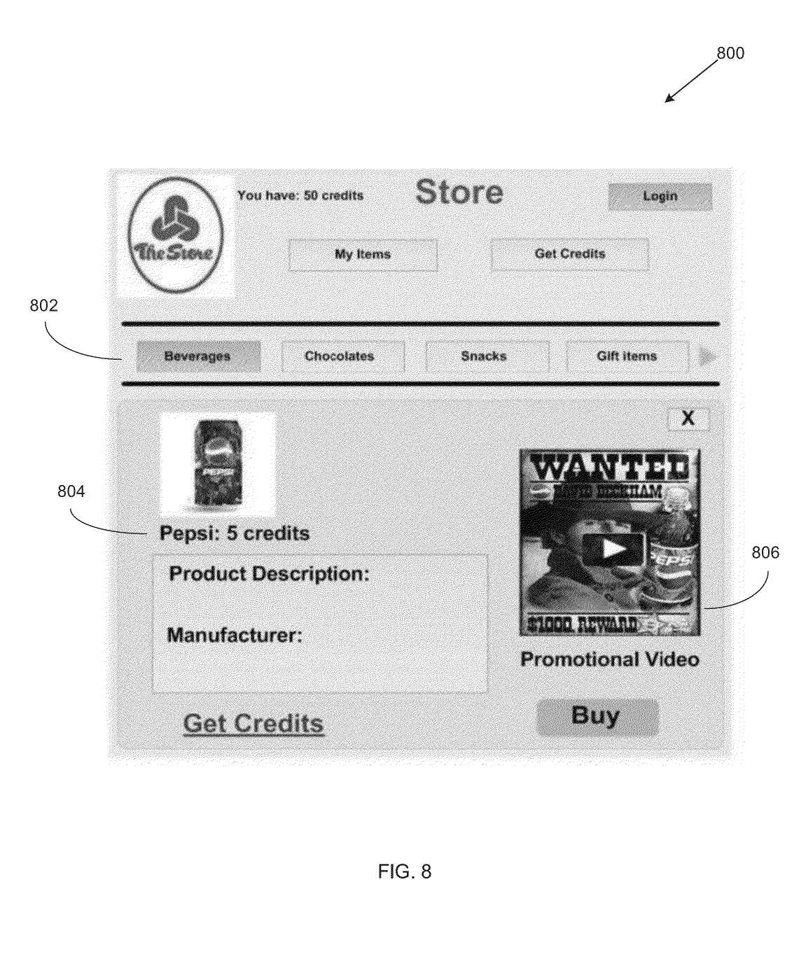

FIG. 8 illustrates an exemplary virtual store that displays information for an exemplary product or service purchased with a plurality of credits, in accordance with an embodiment of the present invention. In the present invention, a virtual store 800 may display the products or services of the various companys that signed up with the administrator. In one embodiment, a general products portion 802 in the store may describe the product types, including, without limitation, beverages, chocolates, snacks, and gift items. Upon selecting a general product, a specific menu of that product type may display in the store. A price portion 804 may display the amount of credits necessary to obtain a specific product. A promotional video 806 may then display to encourage the player to select the product or service. In some embodiments, the promotional video may include a five second view of a billboard style advertisement. In another embodiment, the company may pay an additional fee for the promotional video to play for a longer period of time. In this manner, the company may advertise to the player.

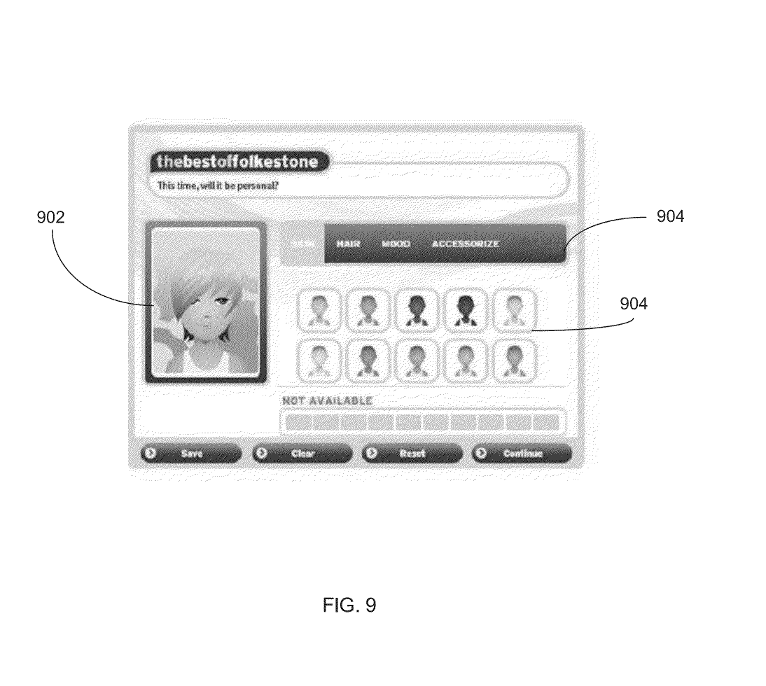

FIG. 9 illustrates an exemplary digital image in the form of an exemplary avatar having a plurality of attributes available for selection, in accordance with an embodiment of the present invention. In the present invention, a player may create a desired digital image 900 for playing the game with. The player may select from a plurality of attributes 902 that represent the player's personality or opinions. The player may create an avatar with a desired set of characteristics and attributes. In some embodiments, the player may select from a plurality of attributes including, without limitation, species, gender, hair color, dexterity, speed, intelligence, and charisma.

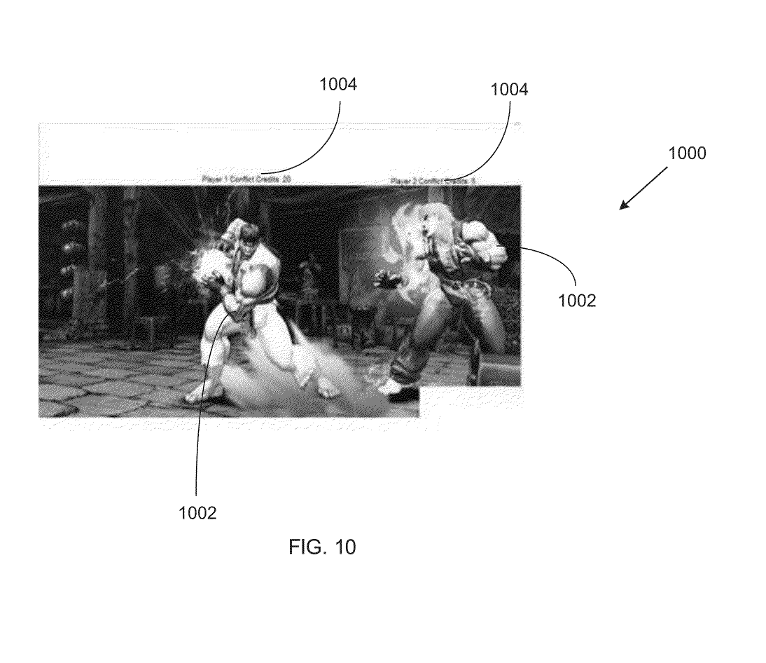

FIG. 10 illustrates an exemplary fight between two exemplary digital images representing players, in accordance with an embodiment of the present invention. In the present invention, a conflict 1000 may ensue upon a challenge being given by a challenging player and accepted by a challenged player. At least one digital image 1002 representing each player may participate in the conflict. Each digital image may include an avatar representation of each respective player. The avatar may be configured to perform efficiently in a physical conflict. The avatar may also include a weapon for performing the conflict. The conflict may include, without limitation, a fist fight, a wrestling match, and a boxing match. The fight may take place under a specific set of rules or be unregulated. In some embodiments, a conflict credit portion 1004 may display the amount of conflict credits available to each player. The conflict credits may increase or decrease during the fight. In some embodiments, the player's avatar may be killed during the fight, whereby the player may select or purchase a different avatar to continue playing in future games. In one embodiment, a fight sequence may include, without limitation, a one-on-one, two dimensional, side view, real-time fighting game similar to previously known fighting games. The conflict between players may be similar to fighting games including, without limitation, Street Fighter™, Mortal Kombat™, and Tekken™. In yet another embodiment, the fight sequence may include isometric view, turn-based, and involves a variety of weapons, armor and other items equipped by the players from a virtual store. In another embodiment, more than two players may be involved in the fight sequence for a brawl sequence. In another embodiment, each individual player has personal fight statistics and characteristics, such as, but not limited to, character level, strength, hit points, defense, speed, or special maneuvers, that can be upgraded, without limitation, by purchasing upgrades in the virtual store, winning fights, and winning poker games.

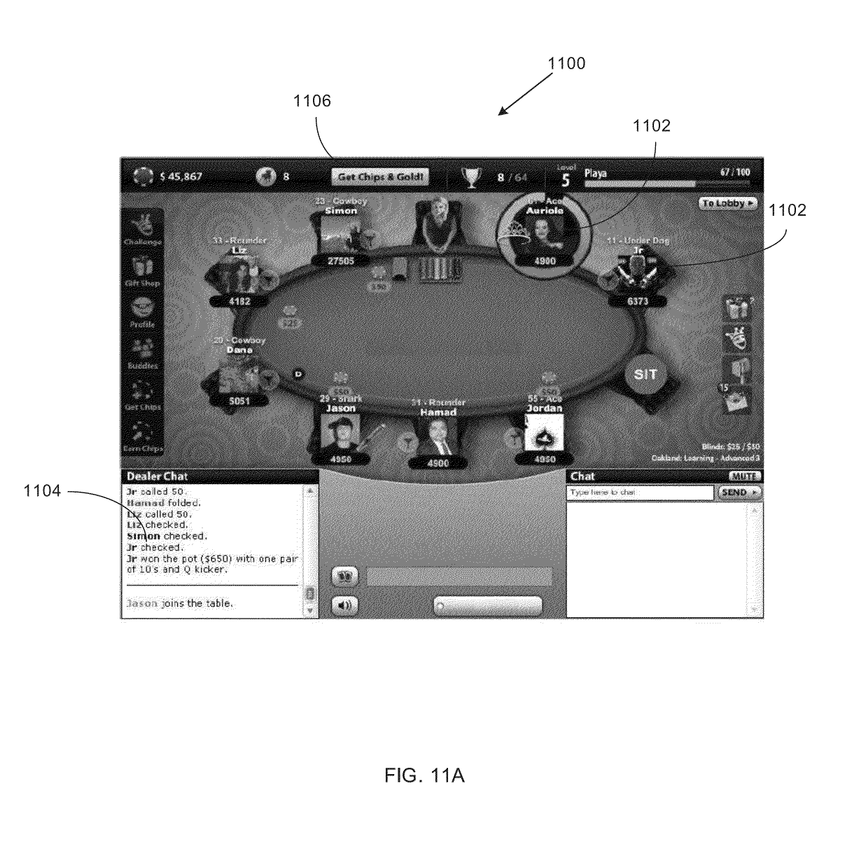

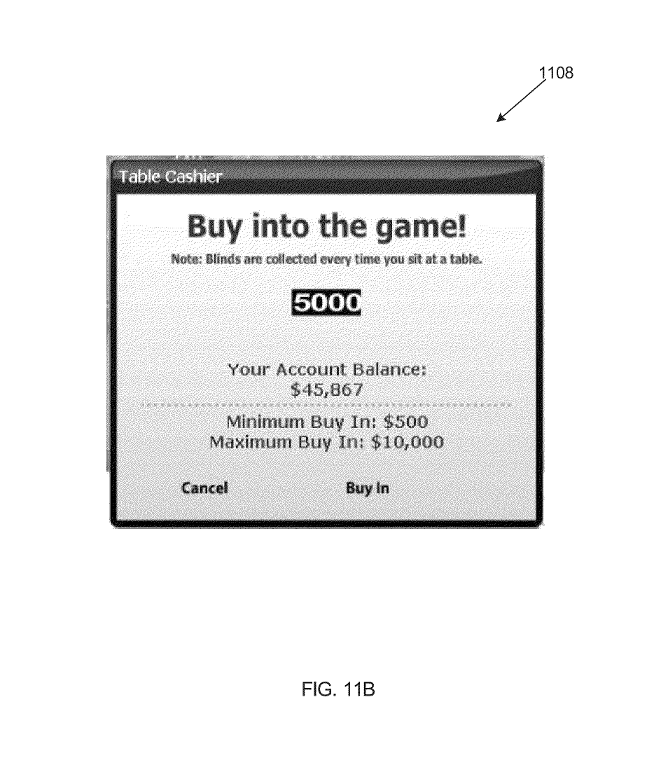

FIGS. 11A and 11B illustrate an exemplary poker game between a plurality of players, in accordance with an embodiment of the present invention, where FIG. 11A illustrates an exemplary graphical depiction of exemplary digital images positioned around a poker table, and FIG. 11B illustrates an exemplary dialogue box inviting the exemplary player to pay an exemplary plurality of credits to play the poker game. In the present invention, a plurality of players represented by a plurality of digital images 1102 may play a poker game. The players may position around a digital representation of a poker table. A chat display portion 1104 may allow each player to view comments made by other players during the poker game. A credit access portion 1106 may allow the player to access conflict credits, regular credits, and poker chips for initiating a conflict challenge or purchasing products or services. In some embodiments, a credit tabulation portion 1108 may provide the player with an updated status of the conflict credits or monetary funds available to play the poker game, or won during the poker game. In the poker game embodiment, the plurality of conflict or regular credits may be accrued by the player by betting the credits in a similar manner to how chips or money are traditionally bet in poker. In another embodiment, the credits may accrue automatically in a manner proportional to the number of games played or to the amount of time spent playing the game. The player may then visit the virtual store to purchase the desired product or service.

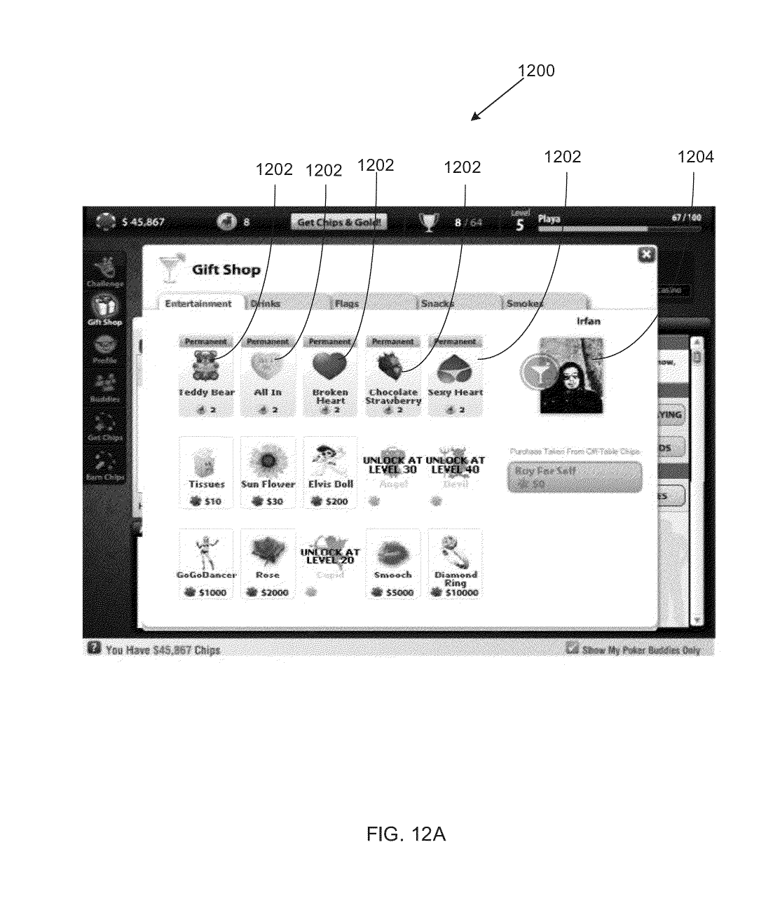

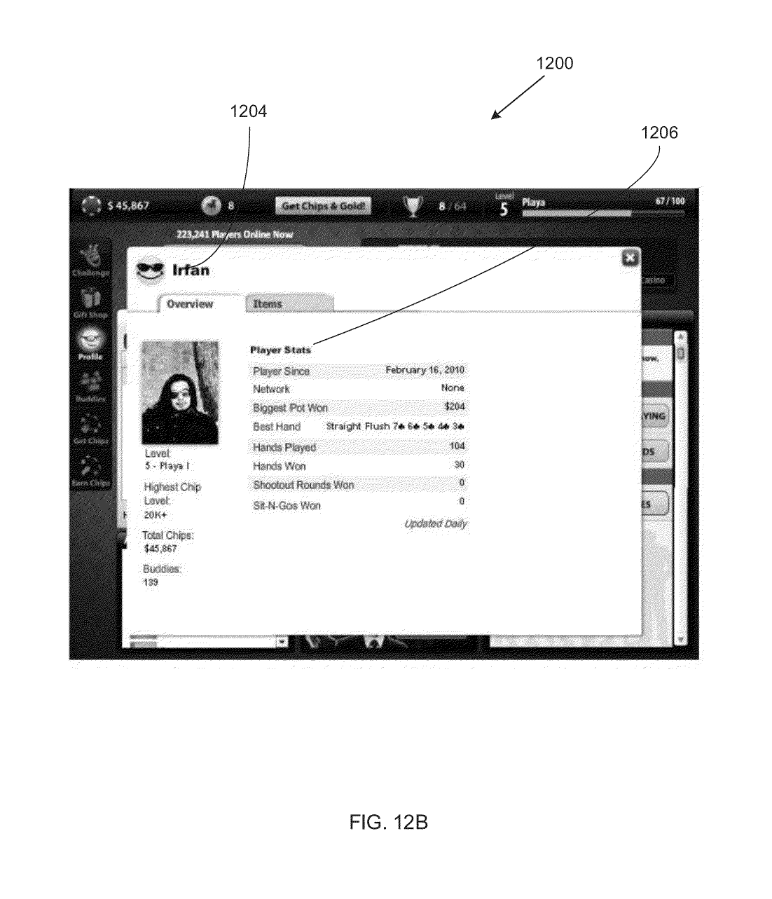

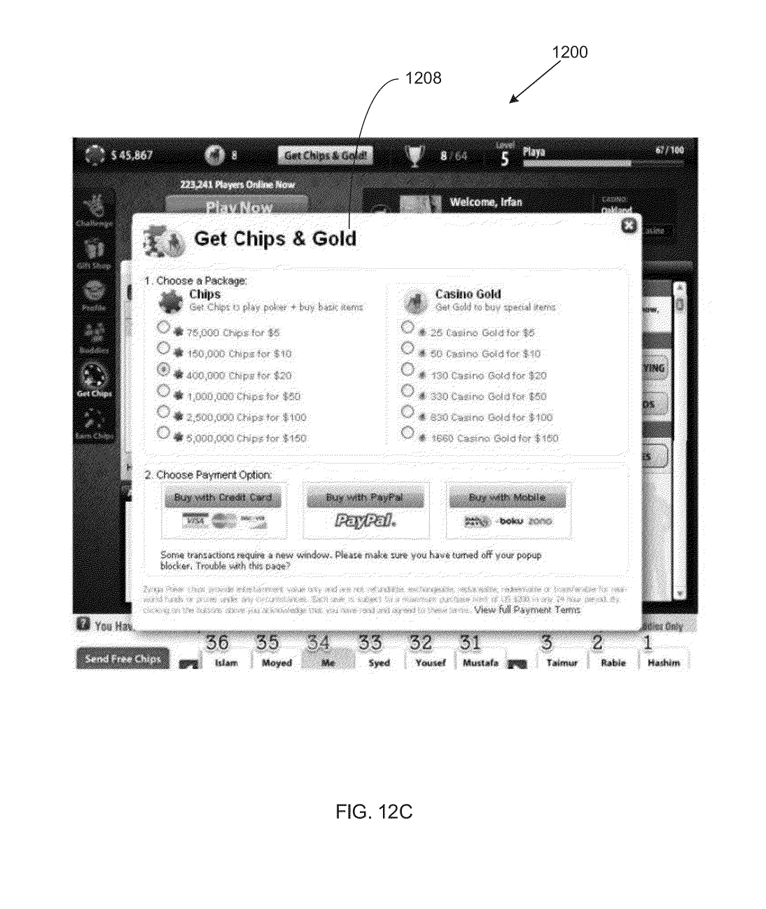

FIGS. 12A, 12B, and 12C illustrate an exemplary poker game between a plurality of players, in accordance with an embodiment of the present invention, where FIG. 12A illustrates an exemplary virtual store displaying a plurality of exemplary products or services, FIG. 12B illustrates an exemplary digital image of an exemplary avatar with exemplary plurality of credits and game history, and FIG. 12C illustrates an exemplary dialogue box inviting an exemplary player to purchase a plurality of credits to play the poker game. In the present invention, a game status portion 1200 may provide the player information about the status of the game and the status of the player's products or services. The game status portion may include a virtual gift store that displays a plurality of gifts available for purchase for the player's avatar or other players' avatars. In one alternative embodiment, the product or service may be shipped to the player for personal consumption, whereby the product or service is not virtual, but real. In some embodiments, a plurality of products or services 1202 may display in proximity to each other. Each product may display next of a similar product. For example, without limitation, various types of chocolates display on a graphical menu. The player may then select a desired chocolate for the avatar to eat, or to gift another player's avatar. A digital image portion 1204 may display a graphical representation of the player's avatar and attributes of the avatar. A player statistics portion 1206 may list the statistics of the game for the player. The statistics may include, without limitation, the pot won, the best poker hand dealt, the amount of poker hands won, and the date the player joined the network of the game. In some embodiments, a credit access portion 1208 may allow the player to purchase additional credits or poker chips for purchasing the products or services in the store, or play the poker game. In this manner, the player may view, purchase, and consolidate products or services while playing the game. In yet another embodiment, the player may view a credit portion to see the amount of conflict credits available for each player playing the game.

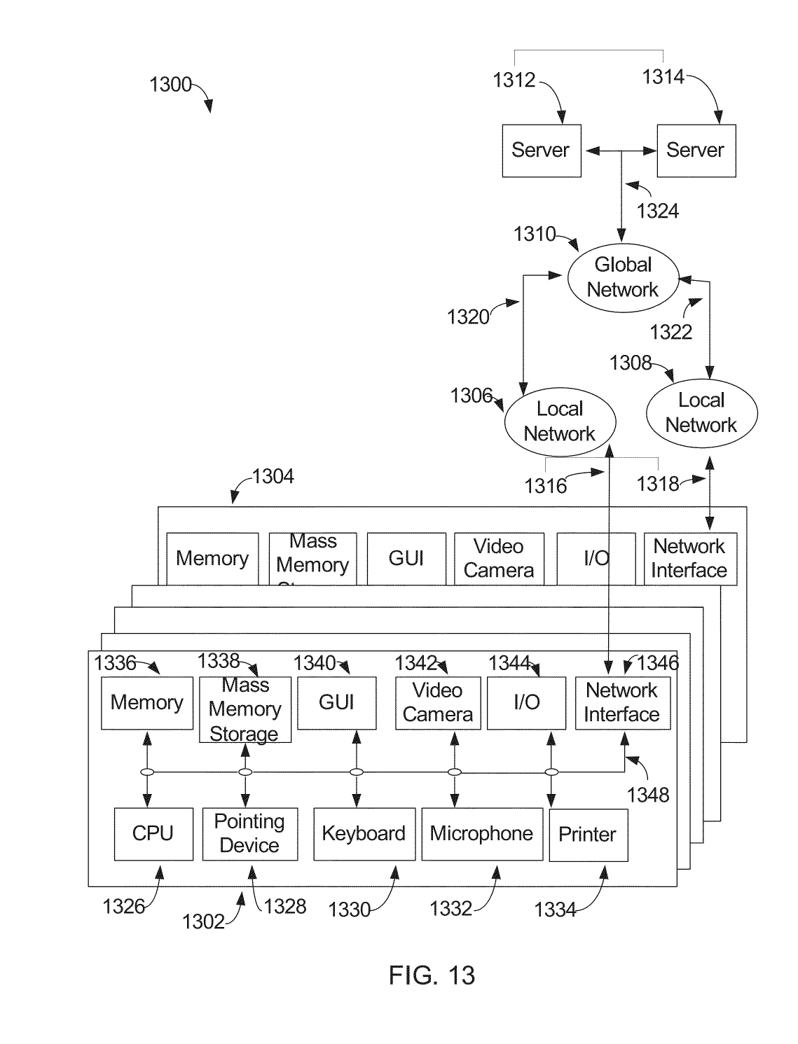

FIG. 13 illustrates a block diagram of an exemplary computer system that, when appropriately configured or designed, may serve as an exemplary monetizing method and system, in accordance with an embodiment of the present invention. In the present invention, a communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing monetization of a conflict between avatars while selling player information and access to the game to a company according to the present invention will be apparent to those skilled in the art. Various aspects of the invention have been described above by way of illustration, and the specific embodiments disclosed are not intended to limit the invention to the particular forms disclosed. The particular implementation of the monetization of a conflict between avatars while selling player information and access to the game to a company may vary depending upon the particular context or application. By way of example, and not limitation, the monetization of a conflict between avatars while selling player information and access to the game to a company described in the foregoing were principally directed to a game administrator that charges companies a fee to integrate products or services into a game for viewing by a player implementations; however, similar techniques may instead be applied to marketing products or services through the use of word processing software at work sites, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. One or more computer storage media storing computer-usable instructions, that when used by one or more computing devices, cause the one or more computing devices to perform a method comprising the steps of:
(a) playing a game;
(b) earning at least one conflict credit, at least partially for winning said game;
(c) spending said at least one conflict credit to issue a conflict challenge to at least one player;
(d) accepting or refusing said conflict challenge;
(e) separating a plurality of conflict challenge players from said game, at least partially based on acceptance of said conflict challenge;
(f) commencing said conflict challenge;
(g) resuming said game, said resuming said game comprising at least passively participating in said conflict challenge; and
(h) rewarding a winning conflict challenge player.

2. The method of claim 1, in which said game playing step in (a) further comprises the step of playing a poker game.

3. The method of claim 2, in which said game playing step in (a) further comprises the step of playing a poker game as an avatar.

4. The method of claim 1, in which said earning at least one conflict credit step in (b) further comprises the step of purchasing said at least one conflict credit.

5. The method of claim 4, in which said earning at least one conflict credit, at least partially for winning said game step in (b) further comprises the step of succeeding at said poker game with a winning hand.

6. The method of claim 1, in which said spending said at least one conflict credit to issue a conflict challenge step in (c) further comprises the step of spending said at least one conflict credit to issue a challenge for a physical fight.

7. The method of claim 6, in which said spending said at least one conflict credit to issue a conflict challenge step in (c) further comprises the step of spending said at least one conflict credit for a product and/or service.

8. The method of claim 7, in which said spending said at least one conflict credit to issue a conflict challenge step in (c) further comprises the step of a company integrating said product and/or service into said game.

9. The method of claim 8, in which said spending said at least one conflict credit to issue a conflict challenge step in (c) further comprises the step of charging said company a monetary fee for integrating said product and/or service into said game.

10. The method of claim 9, in which said spending said at least one conflict credit to issue a conflict challenge step in (c) further comprises the step of including a virtual store in said game for selling said product and/or service.

11. The method of claim 10, in which said spending said at least one conflict credit to issue a conflict challenge step in (c) further comprises the step of said avatar using said product and/or service while playing said game.

12. The method of claim 1, in which said accepting or refusing said conflict challenge step in (d) further comprises the step of refusing said challenge and resuming said game.

13. The method of claim 1, in which said separating a plurality of conflict challenge players from said game step in (e) further comprises the step of dealing said plurality of conflict challenge players out of said poker game.

14. The method of claim 13, in which said separating a plurality of conflict challenge players from said game step in (e) further comprises the step of moving said plurality of conflict challenge players to a different room from said poker game.

15. The method of claim 1, in which said commencing said conflict challenge step in (f) and said resuming said game step in (g) are at least partially simultaneous.

16. The method of claim 15, in which said at least one player resumes said game with at least passive participation in said conflict challenge step in (g) further comprises the step of watching said conflict challenge.

17. The method of claim 16, in which said at least one player resumes said game with at least passive participation in said conflict challenge step in (g) further comprises the step of placing a wager on an outcome of said conflict challenge.

18. The method of claim 1, in which said rewarding a winning conflict challenge player step in (h) further comprises the step of rewarding a winning conflict challenge player with said at least one conflict credit.

19. A system for monetizing conflicts comprising:
means for playing a game;
means for earning at least one conflict credit, at least partially for winning said game;
means for spending said at least one conflict credit to issue a conflict challenge to at least one player;
means for accepting or refusing said conflict challenge;
means for separating a plurality of conflict challenge players from said game, at least partially based on said accepting said conflict challenge;
means for commencing said conflict challenge;
means for resuming said game, said resuming comprising at least passively participating in said conflict challenge; and
means for rewarding a winning conflict challenge player.

20. A non-transitory program storage device readable by a machine tangibly embodying a program of instructions executable by the machine to perform a method for monetizing conflicts, the storage device comprising:
(a) computer code for playing a game, said game comprising a poker game, said playing a game step in (a) further comprising playing said game as an avatar;
(b) computer code for earning at least one conflict credit, at least partially for winning said game, said earning at least one conflict credit step in (b) further comprising the step of purchasing said at least one conflict credit;
(c) computer code for spending said at least one conflict credit to issue a conflict challenge to at least one player, said conflict challenge comprising a physical fight, said at least one conflict credit to issue a conflict challenge step in (c) further comprising the step of spending said at least one conflict credit for a product and/or service, said spending said at least one conflict credit to issue a conflict challenge step in (c) further comprising the step of a company integrating said product and/or service into said game, said spending said at least one conflict credit to issue a conflict challenge step in (c) further comprising the step of charging said company a monetary fee for integrating said product and/or service into said game, said spending said at least one conflict credit to issue a conflict challenge step in (c) further comprising the step of including a virtual store in said game for selling said product and/or service, spending said at least one conflict credit to issue a conflict challenge step in (c) further comprising the step of said avatar using said product and/or service while playing said game;
(d) computer code for accepting or refusing said conflict challenge;
(e) computer code for separating a plurality of conflict challenge players from said game, at least partially based on acceptance of said conflict challenge, said separating a plurality of conflict challenge players from said game step in (e) further comprising the step of dealing said plurality of conflict challenge players out of said poker game;
(f) computer code for commencing said conflict challenge;
(g) computer code for resuming said game, said resuming said game comprising at least passively participating in said conflict challenge, said at least one player resumes said game with at least passive participation in said conflict challenge step in (g) further comprising the step of watching and/or placing a wager on an outcome of said conflict challenge; and
(h) computer code for rewarding a winning conflict challenge player, said rewarding a winning conflict challenge player step in (h) further comprising the step of rewarding a winning conflict challenge player with said at least one conflict credit.
